(19) United States
(12) Patent Application Publication
(10) Pub. No.: US 2006/0221206 A1
(43) Pub. Date: Oct. 5, 2006

(54) Web camera with dynamic light compensation control responsive to ambient light levels

(75) Inventors: Yong-Sheng Lin, Taipei (TW); Zhen-Rong Dai, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 11/095,506

(22) Filed: Apr. 1, 2005

(51) Int. Cl. H04N 9/73

(52) U.S. Cl. 348/227.1

(57) ABSTRACT

A web camera has a light sensor, a digital signal processor (DSP), a driving circuit, and a light source. When the light sensor detects that the ambient illumination is lower than a predetermined amount, the DSP will command the driving circuit to power the light source to provide increased illumination.

### BACKGROUND OF THE INVENTION

1. Field of the Invention

The present invention relates to a web camera, and in particular, to a web camera with light compensation control including a light sensor and a light source that is turned on in response to low ambient light. The intensity of light output by the light source is dynamically controlled by a processor connected to the light sensor.

2. Description of the Prior Art

Web cameras are becoming increasingly popular for use in peer-to-peer communications, or on-line surveillance. The conventional web camera is usually used in a limited illumination space, such as an office, study room or warehouse. When the illumination is low, a remote video viewer will watch an image or video stream of very poor quality.

A known improvement is to provide an ON-OFF light compensation control. As soon as the operator detects that the ambient illumination is lower than he needs, or a complaint is received from a remote video viewer, the operator may turn on a light, such as a white LED, attached to the web camera for obtaining a better quality in viewing the video stream. However, the light compensation manual control (ON-OFF) tends to cause an underexposure or overexposure of the video stream.

Patent Publication Nos. WO02098141 and U.S. Pat. No. 5,523,786 disclose a color compensation control system in RGB (red, green, blue) colors for a still CCD (Charge-Coupled Device) camera. However, the color compensation control only depends on how many LED lights have been turned on in different ratios of RGB colors so as to grant a better image in color balance.

### SUMMARY OF THE INVENTION

It is an object of the present invention to provide a web camera with dynamic light compensation control.

It is another object of the present invention to provide a web camera with dynamic light compensation control via a light sensor which is built into a CMOS (Complementary Metal Oxide Semiconductor) image sensor.

It is yet another object of the present invention to provide a web camera with dynamic light compensation control via an extra light sensor

To accomplish the objectives mentioned above, the web camera comprises a light sensor, a digital signal processor (DSP), a driving circuit, and a light source. Once the light sensor detects that the ambient light level is lower than a predetermined amount, the DSP will command the driving circuit to power the light source to illuminate the ambience.

### BRIEF DESCRIPTION OF THE DRAWINGS

FIG. 1 is a perspective view of a web camera constructed in accordance with the principles of a preferred embodiment of the present invention.

FIG. 2 is a block diagram of a first embodiment of the web camera of FIG. 1.

FIG. 3 is a schematic circuit diagram showing a second embodiment of the web camera of FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

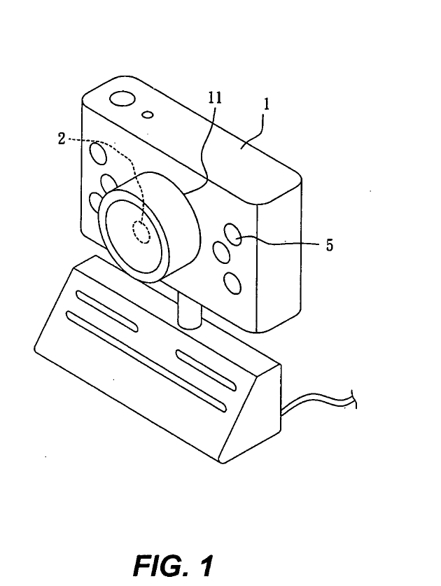

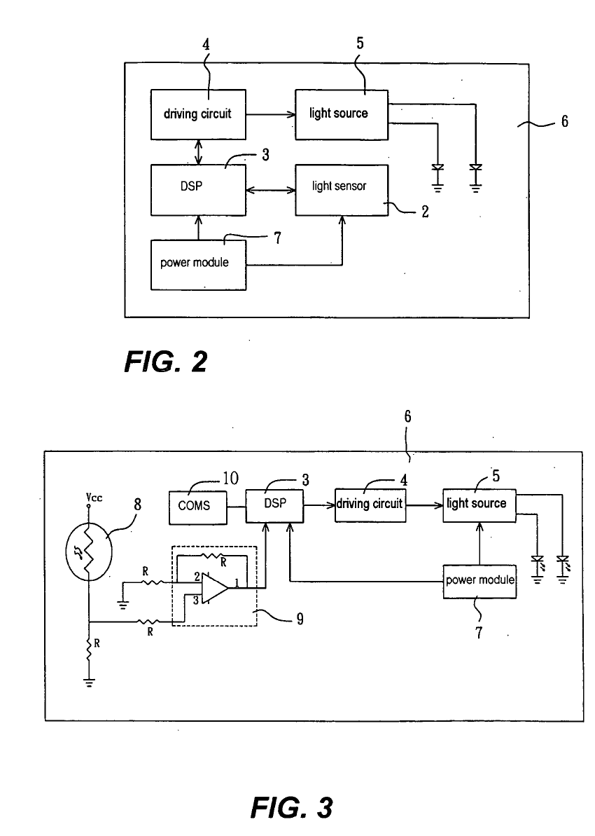

Referring to FIGS. 1 and 2, the web camera according to the invention comprises a body 1, a light sensor 2, a digital signal processor (DSP) 3, a driving circuit 4 and at least a light source 5. An opening 11 is located in front of the body 1 allowing the light ambient light to enter therethrough. The light sensor 2 is located within the body 1 adjacent to the opening 11 for detecting the entry of ambient light. One end of the DSP 3 couples to the light detector 2, and another end of the DSP 3 couples to the driving circuit 4 for activating the light source 5. Light source 5 may be, but is not limited to, a white light-emitting diode (LED). The intensity of illumination provided by the LED is managed by DSP 3.

The light sensor 2 will detect the illumination provided by ambient light through the opening 11, and the DSP 3 will determine if the illumination is sufficient. Once the ambient light level is lower than a predetermined value, the DSP 3 will force the driving circuit 4 to power the light source 5 so as to dynamically emit light of variable intensity depending on the ambient illumination level. Therefore, the remote end viewer will a receive video stream in the best possible condition.

The light sensor 2, DSP 3, driving circuit 4, and light source 5 of the embodiment of FIG. 2 can be located on a circuit board 6. The light sensor 2 can be built into the CMOS image sensor to lower the cost of manufacture. In addition, a power module 7 may be connected to a computer (not shown) so as to supply electricity from the computer to the light sensor 2, DSP 3, driving circuit 4, and light source 5.

Referring to FIGS. 1 and 3, the web camera according to the invention comprises a body 1, a light sensor 8, amplifying circuit 9, CMOS image sensor 10, digital signal processor (DSP) 3, a driving circuit 4 and at least a light source 5. An opening 11 is located in front of the body 1 allowing ambient light to enter therethrough. The light sensor 8, such as a photoresistor/CdS, is located within the body 1 adjacent to the opening 11 for detecting the light coming form the surroundings. One end of the DSP 3 is coupled to the CMOS image sensor, and another end of the DSP 3 is coupled to the amplifying circuit 9. The DSP 3 is further coupled to the driving circuit 4 for activating the light source 5, which may again be by way of example and not limitation a white light-emitting diode (LED). The intensity of illumination provided by the LED is managed by DSP 3.

The light sensor 8 will detect the ambient illumination through the opening 11 and forward a detection signal to the amplifying circuit 9, such as an operational amplifier or OpAmp. The DSP 3 will receive the amplified signal and determine if the detected ambient illumination is sufficient. When the ambient illumination is lower than a predetermined value, the DSP 3 will force the driving circuit 4 to power the light source 5 as to dynamically emit light of variable intensity depending on the level of illumination. Therefore, the remote end viewer will receive a video stream in the best condition.

The CMOS image sensor 10, light sensor 2, DSP 3, driving circuit 4, and light source 5 of the embodiment of FIG. 3 can be located on a circuit board 6. In addition, a power module 7 may be connected to a computer (not shown) to supply electricity from the computer to the light sensor 8, amplifying circuit 9, DSP 3, driving circuit 4, and light source 5.

By the improvement mentioned above, the remote video viewer will obtain a better quality video stream for watching or monitoring across the network.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A web camera with dynamic light compensation control, comprising:
a body having an opening;
a light sensor for detecting ambient illumination through the opening;
a processor coupled to the light sensor;
a driving circuit coupled to the processor; and
a light source coupled to the driving circuit;
wherein when the light sensor detects that the ambient illumination is lower than a predetermined level, the processor activates the driving circuit for dynamically illuminating the light source.

2. The web camera as claimed in claim 1, wherein the light sensor is built into a CMOS image sensor.

3. The web camera as claimed in claim 1, wherein the processor is a digital signal processor.

4. The web camera as claimed in claim 1, wherein the driving circuit is an LED driving circuit.

5. The web camera as claimed in claim 1, wherein the light source at least includes a white LED.

6. The web camera as claimed in claim 1, wherein the light sensor is a photoresistor.

7. The web camera as claimed in claim 6, wherein the camera further comprises an amplifying circuit which is located between the photoresistor and the processor.

8. The web camera as claimed in claim 7, wherein the amplifying circuit is an operational amplifier.

9. The web camera as claimed in claim 1, wherein the web camera is coupled to a computer, and further has a power module connected to the computer.

10. A web camera with dynamic light compensation control, comprising:
a body having an opening;
a light sensor for detecting ambient illumination through the opening;
a processor coupled to the light sensor;
a CMOS image sensor coupled to the processor;
a driving circuit coupled to the processor;
a light source coupled to the driving circuit;
wherein when the light sensor detects that the ambient illumination is lower than a predetermined amount, the processor activates the driving circuit for dynamically illuminating the light source.

11. A web camera coupled to a computer with dynamically light compensation control, comprising:
a body having an opening;
a CMOS image sensor with a built-in light sensor for detecting ambient illumination through the opening;
a processor coupled to the light sensor;
a driving circuit coupled to the processor;
a light source coupled to the driving circuit;
wherein when the light sensor detects that the ambient illumination is lower than a predetermined amount, the processor activates the driving circuit for dynamically illuminating the light source.
